(19) United States
(12) Patent Application Publication
(10) Pub. No.: US 2024/0312218 A1
(43) Pub. Date: Sep. 19, 2024

(54) SYSTEM AND METHOD FOR GENERATING A FUSED ENVIRONMENT REPRESENTATION FOR A VEHICLE

(71) Applicant: Mercedes-Benz Group AG, Stuttgart (DE)

(72) Inventors: Gunther Krehl, Sunnyvale, CA (US); Thomas Monninger, Sunnyvale, CA (US); Manuel Schier, Sunnyvale, CA (US); Stanislaw Antol, Sunnyvale, CA (US); Aaron Brown, Sunnyvale, CA (US); Daniel Stang, Sunnyvale, CA (US)

(21) Appl. No.: 18/121,551

(22) Filed: Mar. 14, 2023

(51) Int. Cl. G06V 20/58; B60W 60/00

(52) U.S. Cl. CPC G06V 20/58; B60W 60/001; B60W 2420/408

(57) ABSTRACT

A vehicle computing system can receive raw sensor data in both a traditional sensor data processing module and a learned sensor data processing module. Each module can reproject sensor data in BEV space, and can optionally perform sensor fusion when multiple sensor data types are processed. The system can then combine the learned BEV grid map or volume and the traditional BEV grid map or volume to generate a hybrid BEV representation of a surrounding environment of the vehicle, and process the hybrid BEV representation of the surrounding environment to derive a fused representation of the surrounding environment of the vehicle

### BACKGROUND

An advanced driver assistance system (ADAS) of a vehicle utilizes sensor information to automatically perform driver assist functions, such as collision warning, blind spot monitoring, adaptive cruise control, emergency braking, automatic parking, automated lane centering and lane following, and the like. The Society of Automotive Engineers (SAE) provides multiple levels of driving automation, with Level 0 corresponding to no driving automation and Level 5 corresponding to full driving automation.

### SUMMARY

Systems and methods are described herein for dynamically generating a sensor-fused, surrounding environment representation for a vehicle using (i) a traditional grid, such as a traditional bird's eye view (BEV) grid map or volume generated from raw sensor data in which the sensor measurements are reprojected into the grid or volume using geometric formulas, and (ii) a learned BEV volume generated by a learned sensor data processing module. A computing system of the vehicle can receive raw sensor data from a sensor suite of the vehicle, which can include multiple sensor types, such as a set of LIDAR sensors, radar sensors, cameras or other image sensors, ultrasonic sensors, etc. In certain examples, he computing system can execute a traditional reprojection and grid sensor fusion module to process the raw sensor data measurements from the sensor suite of the vehicle and generate the traditional BEV grid map or volume in a classical manner, such that no machine learning model is used for generating the traditional BEV grid map or volume, and a set of captured sensor data is represented in the traditional BEV grid from traditional reprojection using inverse sensor models.

Simultaneously, the computing system can execute a learned sensor data processing module to generate a set of one or more learned two-or-three-dimensional BEV grid maps or volumes based on the raw sensor data. In some aspects, the learned BEV grid map or volume can comprise a single, sensor-fused, learned BEV volume generated from each of the plurality of sensor types (fused LIDAR, radar, and image data). In variations, the learned BEV grid map or volume can be a single learned BEV grid map or volume based on a single sensor data type (e.g., image data), or can be a combined BEV grid map or volume (e.g., concatenated) from individual sensor data maps or volumes for each of one or more sensor data types, such as a learned BEV grid map or volume comprised of image data, a learned BEV grid map or volume comprised of radar data, and/or a learned BEV grid map or volume comprised of LIDAR data.

In certain implementations, the traditional sensor data processing module can perform inverse sensor modeling on the raw sensor measurements to generate the traditional BEV grid map or volume. In further implementations, the computing system can combine the traditional BEV grid map or volume and the learned BEV map(s) or volume(s) along spatial dimensions such that the features from the BEV grid map or volume and the learned BEV map(s) or volume(s) are spatially correlated. The computing system may then process the resultant hybrid BEV representation of the surrounding environment of the vehicle to, for example, derive a fused representation of the surrounding environment, derive various aspects of the road infrastructure on which the vehicle operates (e.g., lane markings, road topology, lane topology, crosswalks, etc.), perform scene understanding tasks (e.g., object detection and classification, determine right-of-way rules, etc.), determine grid occupancy, perform motion prediction, perform driver assistance tasks, or autonomously operate the vehicle along a travel route.

### BRIEF DESCRIPTION OF THE DRAWINGS

The disclosure herein is illustrated by way of example, and not by way of limitation, in the figures of the accompanying drawings in which like reference numerals refer to similar elements, and in which:

FIG. 1 is a block diagram depicting an example computing system for generating a fused environment representation for a vehicle, according to examples described herein;

FIG. 2 is a block diagram illustrating an example vehicle computing system including specialized modules for generating a sensor-fused, environment representation for a vehicle, according to examples described herein;

FIG. 3 depicts an example of a vehicle acquiring sensor data from multiple sensor types to generate a fused representation of the surrounding environment, according to examples described herein; and

FIGS. 4 and 5 are flow charts describing example methods of combining a traditional BEV grid map or volume with a learned BEV map or volume to perform automated vehicle tasks, according to examples described herein.

### DETAILED DESCRIPTION

Systems and methods are described herein of generating an environment representation for a vehicle that is suitable to support all SAE levels and all operational design domains (ODDs), and that is certifiable for all necessary functional safety standards. Motion planning and driver assistance techniques in real-world environments require a versatile model of the environment, such that the high-level features of the environment representing complex patterns are captured to perform scene understanding tasks, and such that sensor measurements are able to be processed in an interpretable manner for safety purposes. A vehicle computing system can include a traditional reprojection and grid sensor data processing module and a learned sensor data processing module that can each receive raw sensor data from various sensors of the vehicle. The traditional sensor data processing module can generate a traditional BEV grid map using inverse sensor models (e.g., a two-dimensional grid map or three-dimensional grid volume) of the surrounding environment of the vehicle using the captured sensor data, while the learned sensor data processing module can generate a learned BEV map or volume of the surrounding environment of the vehicle based on one or more downstream tasks (e.g., ADAS tasks, autonomous driving tasks, scene understanding tasks, grid occupancy determination tasks, motion prediction, motion planning, etc.).

In various implementations, the computing system can concatenate or otherwise combine the traditional BEV grid map or volume and the learned BEV map or volume to generate a hybrid, grid-based, BEV representation of the surrounding environment of the vehicle. It is contemplated that use of the classical grid map can provide a versatile form of representing the surrounding environment of the vehicle, such that integration of the grid map or volume (e.g., using traditional inverse sensor modeling) with the learned map or volume is physically verifiable, which can guarantee that occupancy information and other sensor-based details are available to, for example, a motion planner or environment analysis module of the vehicle.

In further implementations, the computing system can utilize the hybrid, grid-based BEV representation to derive a fused representation of the surrounding environment of the vehicle. For example, the computing system can implement a machine learning decoder on the hybrid, grid-based BEV representation to generate the fused representation of the surrounding environment. The computing system may then utilize the fused representation of the surrounding environment of the vehicle to perform a variety of tasks—such as object detection, scene understanding, occupancy grid determination, etc.—in order to facilitate assisted driving or autonomous vehicle operation.

Among other benefits, the examples described herein achieve a technical effect of dynamically creating a sensor-fused, hybrid, grid-based BEV representation of the surrounding environment of a vehicle using both a classical and learning-based approach. As provided herein, a classical or traditional approach utilizes inverse sensor models to reproject the measurements from the sensors into a BEV grid or volume using geometric formulas, which, for example, can be advantageous for LIDAR and radar data. Additionally, the learned approach utilizes data to learn the mapping from the raw sensor measurements to a grid or volume, which, for example, can be advantageous for image data. In various implementations, the traditional and learning approach can generate BEV maps or volumes of a single sensor data type, or can perform sensor fusion using multiple sensor data types. The traditional and learned BEV maps or volumes may then be combined to generate a hybrid BEV map or volume comprising both approaches. It is contemplated that this hybrid integration can provide higher level features necessary for scene understanding and data-driven feature optimization, which can facilitate scalability of the various examples described herein to support advanced SAE levels and ODDs.

As provided herein, a reprojection operation corresponds to a mapping from a sensor frame of reference into a BEV grid or volume frame of reference, and can be learned or traditional performed using inverse sensor models and/or coordinate transforms. As further provided herein, sensor fusion operations combine sensor data from multiple sensors and sensor types, and can also be either learned or traditionally performed using probabilistic formulas to aggregate individual sensor measurements on a cell level. As such, raw sensor data may be transferred to BEV space by reprojection using inverse sensor models and coordinate transforms, and then the sensor fusion occurs thereafter.

As provided herein, each vehicle can encode collected sensor data using an autoencoder, which comprises a neural network that can lower the dimensionality of the sensor data. In various applications, the neural network can comprise a bottleneck architecture that provides for the autoencoder reducing the dimensionality of the sensor data. A decoder can be used for scene reconstruction to enable a comparison between the encoded sensor data and the original sensor data, where the loss comprises the difference between the original and the reconstruction. The data “compression” can comprise the smaller resultant dimensions from the autoencoder, which can result in fewer units of memory being required for storing the data. In some examples, a variational autoencoder is executed on-board the vehicles so that normal distribution resampling along with KL divergence loss can cause the encoded compression to lie only on the observed data's possibilities. It is contemplated that the use of a variational autoencoder on vehicles can further enhance compression due to memory not being wasted on data that is not useful, or data that would resemble noise. Thus, the use of the term “autoencoder” or “machine learning encoder” throughout the present disclosure can refer to a neural network (either general autoencoder, variational autoencoder, or other learning-based encoder) that performs the dimensionality reduction and/or data compression techniques described herein.

As further provided herein, sensor data “volume,” BEV “volume,” or learned BEV “volume” are referred to as captured sensor data and/or reconstructed sensor data that provide for a three-dimensional representation of an environment captured by a set of sensors. A machine learning model (e.g., a machine learning encoder/decoder) can generate a learned BEV volume from raw sensor data, which can comprise fused sensor data from multiple sensor types (e.g., LIDAR, radar, and image). In doing so, the machine learning model can discard certain captured data, compress and/or encode sensor data, augment the sensor data, and/or generate a reconstruction of a real-world, three-dimensional environment based on the compressed and encoded sensor data. Examples described herein may further reference a BEV grid map or a BEV grid volume, which can comprise a two-dimensional, a three-dimensional, or any n-dimensional discretized space (e.g., a space that further includes a temporal dimension). Such terms may be used interchangeably throughout the present disclosure.

In certain implementations, the computing system can perform one or more functions described herein using a learning-based approach, such as by executing an artificial neural network (e.g., a recurrent neural network, convolutional neural network, etc.) or one or more machine-learning models to process the respective set of trajectories and classify the driving behavior of each human-driven vehicle through the intersection. Such learning-based approaches can further correspond to the computing system storing or including one or more machine-learned models. In an embodiment, the machine-learned models may include an unsupervised learning model. In an embodiment, the machine-learned models may include neural networks (e.g., deep neural networks) or other types of machine-learned models, including non-linear models and/or linear models. Neural networks may include feed-forward neural networks, recurrent neural networks (e.g., long short-term memory recurrent neural networks), convolutional neural networks or other forms of neural networks. Some example machine-learned models may leverage an attention mechanism such as self-attention. For example, some example machine-learned models may include multi-headed self-attention models (e.g., transformer models).

As provided herein, a “network” or “one or more networks” can comprise any type of network or combination of networks that allows for communication between devices. In an embodiment, the network may include one or more of a local area network, wide area network, the Internet, secure network, cellular network, mesh network, peer-to-peer communication link or some combination thereof and may include any number of wired or wireless links. Communication over the network(s) may be accomplished, for instance, via a network interface using any type of protocol, protection scheme, encoding, format, packaging, etc.

As further provided herein, an “autonomy map” or “autonomous driving map” can comprise a ground truth map recorded by a mapping vehicle using various sensors (e.g., LIDAR sensors and/or a suite of cameras or other imaging devices) and labeled (manually or automatically) to indicate traffic objects and/or right-of-way rules at any given location. In variations, an autonomy map can involve reconstructed scenes using decoders from encoded sensor data recorded and compressed by vehicles. For example, a given autonomy map can be human-labeled based on observed traffic signage, traffic signals, and lane markings in the ground truth map. In further examples, reference points or other points of interest may be further labeled on the autonomy map for additional assistance to the autonomous vehicle. Autonomous vehicles or self-driving vehicles may then utilize the labeled autonomy maps to perform localization, pose, change detection, and various other operations required for autonomous driving on public roads. For example, an autonomous vehicle can reference an autonomy map for determining the traffic rules (e.g., speed limit) at the vehicle's current location, and can dynamically compare live sensor data from an on-board sensor suite with a corresponding autonomy map to safely navigate along a current route.

One or more examples described herein provide that methods, techniques, and actions performed by a computing device are performed programmatically, or as a computer implemented method. Programmatically, as used herein, means through the use of code or computer-executable instructions. These instructions can be stored in one or more memory resources of the computing device. A programmatically performed step may or may not be automatic.

One or more examples described herein can be implemented using programmatic modules, engines, or components. A programmatic module, engine, or component can include a program, a sub-routine, a portion of a program, or a software component or a hardware component capable of performing one or more stated tasks or functions. As used herein, a module or component can exist on a hardware component independently of other modules or components. Alternatively, a module or component can be a shared element or process of other modules, programs or machines.

Some examples described herein can generally require the use of computing devices, including processing and memory resources. For example, one or more examples described herein may be implemented, in whole or in part, on computing devices such as servers and/or personal computers using network equipment (e.g., routers). Memory, processing, and network resources may all be used in connection with the establishment, use, or performance of any example described herein (including with the performance of any method or with the implementation of any system).

Furthermore, one or more examples described herein may be implemented through the use of instructions that are executable by one or more processors. These instructions may be carried on a non-transitory computer-readable medium. Machines shown or described with figures below provide examples of processing resources and computer-readable mediums on which instructions for implementing examples disclosed herein can be carried and/or executed. In particular, the numerous machines shown with examples of the invention include processors and various forms of memory for holding data and instructions. Examples of non-transitory computer-readable mediums include permanent memory storage devices, such as hard drives on personal computers or servers. Other examples of computer storage mediums include portable storage units, such as flash memory or magnetic memory. Computers, terminals, network-enabled devices are all examples of machines and devices that utilize processors, memory, and instructions stored on computer-readable mediums. Additionally, examples may be implemented in the form of computer-programs, or a computer usable carrier medium capable of carrying such a program.

### Example Computing System

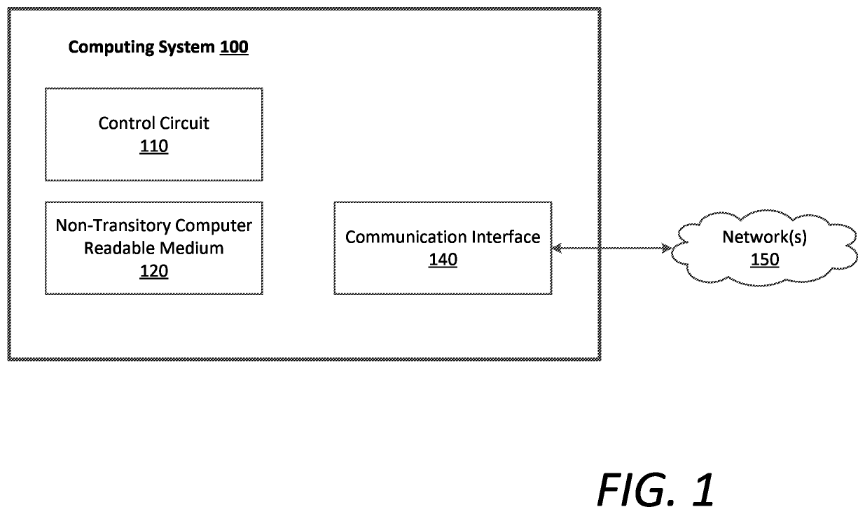

FIG. 1 is a block diagram depicting an example computing system for generating a fused environment representation for a vehicle, according to examples described herein. In an embodiment, the computing system 100 can include a control circuit 110 that may include one or more processors (e.g., microprocessors), one or more processing cores, a programmable logic circuit (PLC) or a programmable logic/gate array (PLA/PGA), a field programmable gate array (FPGA), an application specific integrated circuit (ASIC), or any other control circuit. In some implementations, the control circuit 110 and/or computing system 100 may be part of, or may form, a vehicle control unit (also referred to as a vehicle controller) that is embedded or otherwise disposed in a vehicle (e.g., a Mercedes-Benz® car or van). For example, the vehicle controller may be or may include an infotainment system controller (e.g., an infotainment head-unit), a telematics control unit (TCU), an electronic control unit (ECU), a central powertrain controller (CPC), a central exterior & interior controller (CEIC), a zone controller, or any other controller (the term “or” is used herein interchangeably with “and/or”). In variations, the control circuit 110 and/or computing system 100 can be included on one or more servers (e.g., backend servers).

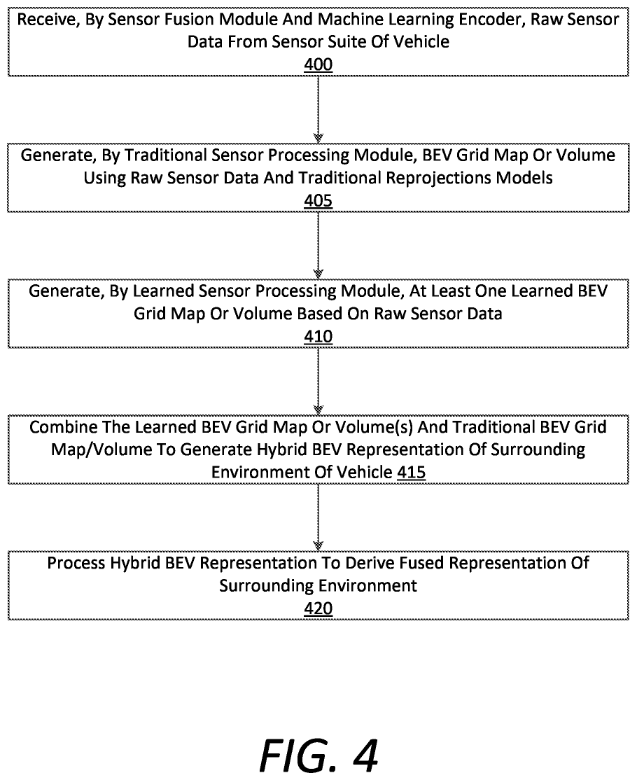

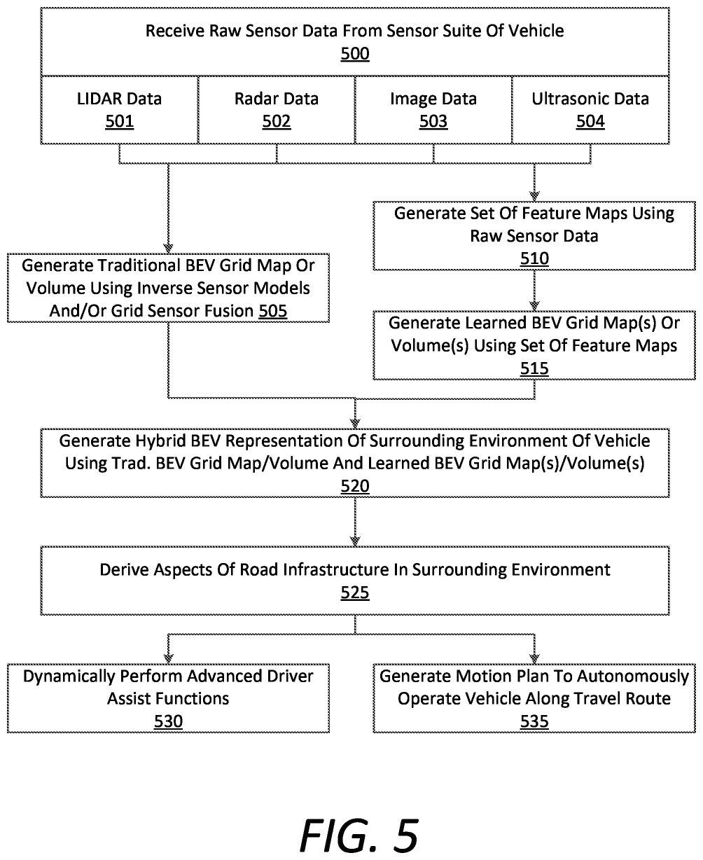

In an embodiment, the control circuit 110 may be programmed by one or more computer-readable or computer-executable instructions stored on the non-transitory computer-readable medium 120. The non-transitory computer-readable medium 120 may be a memory device, also referred to as a data storage device, which may include an electronic storage device, a magnetic storage device, an optical storage device, an electromagnetic storage device, a semiconductor storage device, or any suitable combination thereof. The non-transitory computer-readable medium 120 may form, e.g., a computer diskette, a hard disk drive (HDD), a solid state drive (SDD) or solid state integrated memory, a random access memory (RAM), a read-only memory (ROM), an erasable programmable read-only memory (EPROM or Flash memory), a static random access memory (SRAM), dynamic random access memory (DRAM), a portable compact disc read-only memory (CD-ROM), a digital versatile disk (DVD), and/or a memory stick. In some cases, the non-transitory computer-readable medium 120 may store computer-executable instructions or computer-readable instructions, such as instructions to perform the below methods described in connection with of FIGS. 4A, 4B, 5A, and 5B.

In various embodiments, the terms “computer-readable instructions” and “computer-executable instructions” are used to describe software instructions or computer code configured to carry out various tasks and operations. In various embodiments, if the computer-readable or computer-executable instructions form modules, the term “module” refers broadly to a collection of software instructions or code configured to cause the control circuit 110 to perform one or more functional tasks. The modules and computer-readable/executable instructions may be described as performing various operations or tasks when a control circuit 110 or other hardware component is executing the modules or computer-readable instructions.

In further embodiments, the computing system 100 can include a communication interface 140 that enables communications over one or more networks 150 to transmit and receive data. The communication interface 140 may include any circuits, components, software, etc. for communicating via one or more networks 150 (e.g., a local area network, wide area network, the Internet, secure network, cellular network, mesh network, and/or peer-to-peer communication link). In some implementations, the communication interface 140 may include for example, one or more of a communications controller, receiver, transceiver, transmitter, port, conductors, software and/or hardware for communicating data/information.

As an example embodiment, the computing system 100 can reside on an on-board vehicle computing system, and can receive raw sensor data from a sensor suite of a vehicle, where the sensor suite comprises a plurality of sensor types (e.g., a combination of LIDAR, image, and radar data). The computing system can execute a traditional reprojections and grid sensor fusion module to generate a traditional BEV grid map using the raw sensor data. The computing system can further execute a learned sensor fusion module to generate at least one learned BEV map or volume based on the raw sensor data. The computing system may then combine the one or more learned BEV volumes and the traditional BEV grid map or volume to generate a hybrid BEV representation of a surrounding environment of the vehicle and process the hybrid BEV representation of the surrounding environment to derive a fused representation of the surrounding environment of the vehicle, which can be utilized to perform various assisted and/or autonomous driving tasks described throughout the present disclosure.

### System Description

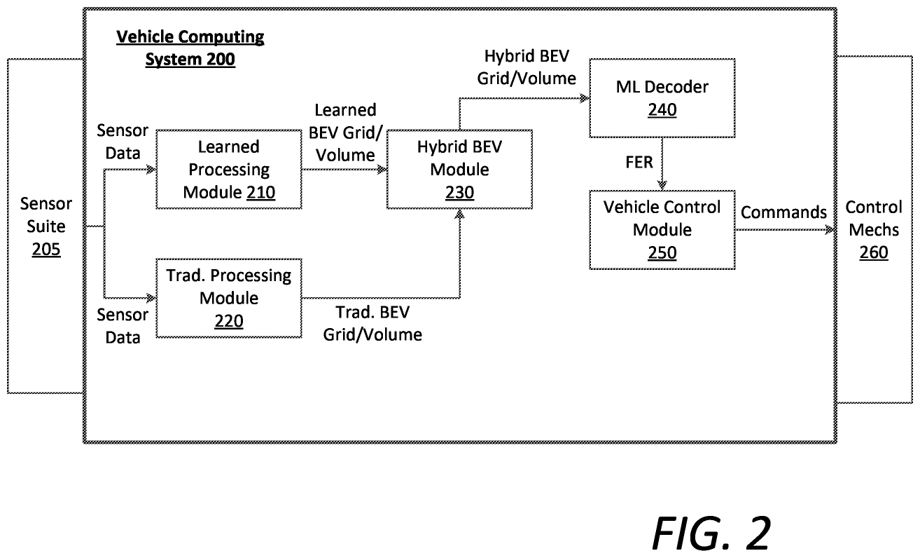

FIG. 2 is a block diagram illustrating an example vehicle computing system including specialized modules for generating a sensor-fused, environment representation for a vehicle, according to examples described herein. In certain examples, the vehicle computing system 200 can be included on a consumer-driven vehicle, which can comprise any vehicle manufactured by an OEM or modified to include a sensor suite 205 comprising a set of sensors, such as image sensors (e.g., cameras), LIDAR sensors, radar sensors, ultrasonic sensors, etc. Additionally or alternatively, the vehicle computing system 200 can be included on a specialized mapping vehicle that operates to collect and/or encode ground truth sensor data of a road network for scene understanding tasks and/or generating autonomy maps for autonomous vehicle operation on a road network.

As the vehicle operates throughout the road network the sensor suite 205 can collect sensor data of multiple sensor types, which can include LIDAR data, image or video data, radar data, and the like. In various examples, the vehicle computing system 200 can include a learned sensor data processing module 210 that processes the sensor data for one or more purposes, as scene understanding for semi-autonomous or fully autonomous driving, ADAS actions, autonomy mapping, and the like. In various implementations, the learned sensor data processing module 210 can transfer the raw sensor data to BEV space (e.g., using inverse sensor models and/or coordinate transforms) and perform sensor fusion on the multiple types of sensor data, and/or encode the sensor fusion-based data (e.g., reduce spatial dimension, discard certain portions of the sensor data, and/or compress the sensor data). In certain examples, the learned sensor data processing module 210 can process the sensor data to generate a set of feature maps in accordance with a set of rules or filters (e.g., a set of feature detectors). In some examples, the learned sensor data processing module 210 can further perform a coordinate transformation to output a learned, sensor-fused BEV volume or a set of learned BEV volumes of different sensor data types.

For example, in certain implementations, the learned sensor data processing module 210 can generate an image-based BEV volume from image data, a LIDAR-based BEV volume from LIDAR data, a radar-based BEV volume from radar data, and/or additional BEV volumes based on addition sensor data. The separate BEV volumes may be concatenated or otherwise combined by a hybrid BEV module 230 of the vehicle computing system 200. In variations, the learned sensor data processing module 210 can transfer the raw sensor data to BEV space by reprojection using inverse sensor models and/or coordinate transforms, and then fuse the sensor data from the multiple sensor types to generate a sensor-fused BEV volume (e.g., comprising each of the image data, LIDAR data, radar data, etc.) to be processed by the hybrid BEV module 230.

According to examples described herein, the vehicle computing system 200 can include a traditional sensor data processing module 220 that performs reprojection and inverse sensor modeling on the raw sensor data from the multiple sensor types of the sensor suite 205 in a classical manner (a non-learning approach). For example, the traditional sensor data processing module 220 can utilize inverse sensor models to reproject the sensor measurements into the BEV grid or volume using geometric formulas, and then fuse the sensor data from the image sensors, LIDAR sensors, and/or radar sensors to generate a sensor-fused BEV grid map or volume,. In further examples, the traditional sensor data processing module 200 can perform a coordinate transformation to generate a traditional BEV grid map, which can comprise a traditional BEV grid based on classical techniques. As provided herein, the traditional BEV grid map can comprise a two-dimensional BEV grid map or a three-dimensional BEV grid volume. The traditional sensor data processing module 220 can comprise a traditional reprojection and grid module-in which a single sensor modality (e.g., LIDAR data) is reprojected into BEV space-or can comprise a traditional reprojection and grid sensor fusion module, which can output a sensor-fused BEV grid map based on multiple types of raw sensor data (e.g., LIDAR and radar data) to the hybrid BEV module 230.

In certain implementations, the traditional sensor data processing module 220 and the learned sensor data processing module 210 can perform sensor fusion on all sensor modalities (e.g., image, LIDAR, and radar data) using both the classical approach and the learned approach respectively. In variations, the modules 210, 220 may perform reprojection techniques on a single sensor data type (in which no fusion is performed), or a subset of selected sensor data types (in which sensor fusion is performed). For example, the traditional sensor data processing module 220 may perform the reprojection into BEV space using a signal type of sensor data (e.g., LIDAR data) in which no sensor fusion is performed, or a subset of multiple types of sensor data (e.g., LIDAR and radar data), where these sensor data types are then fused into a BEV grid map or volume. In an additional example, the learned sensor data processing module 210 can reproject a single sensor data type (e.g., image data) into BEV space (where no sensor fusion is performed), or can reproject a subset of multiple sensor data types into BEV space and performed sensor fusion accordingly.

Thus, the traditional BEV grid or volume outputted by the traditional sensor fusion module

The hybrid BEV module 230 can concatenate or otherwise combine the learned BEV volume(s) from the learned sensor data processing module 210 and the BEV grid map from the traditional sensor data processing module 220 to generate a hybrid BEV grid volume. Accordingly, the hybrid BEV grid volume can include higher-level features that represent complex patterns in the surrounding environment of the vehicle from the learned BEV volume(s) and a traditional sensor data grid from the sensor-fused BEV grid map, which can be verified physically to, for example, support advanced SAE level certifications. As provided herein, such higher-level features can comprise information that would otherwise be lost from the sensor data encoding process by the learned sensor data processing module 210.

In various implementations, the vehicle computing system 200 can include a machine learning decoder 240 that executes on the hybrid BEV grid map to derive a fused environment representation (FER) of the surrounding area of the vehicle (e.g., a grid-based representation). In certain examples, the machine learning decoder 240 processes the encoded sensor data in the hybrid BEV grid volume to generate or otherwise derive the fused environment representation, which in certain examples can comprise a three-dimensional reconstruction of the surrounding environment. As such, the fused environment representation can include a combination of learning-based BEV grid and traditional BEV grid (using inverse sensor models) of the vehicle's surrounding environment for performing any number of functions.

In various examples, the vehicle computing system 200 can include a vehicle control module 250, which can dynamically analyze the fused environment representation. In some embodiments, the vehicle control module 250 can comprise an advanced driver assistance system (ADAS) which can analyze the fused environment representation to perform driver assist functions, such as adaptive cruise control, emergency brake assist, lane-keeping, lane centering, highway drive assist, autonomous obstacle avoidance, and/or autonomous parking tasks. As such, the vehicle control module 250 can operate a set of control mechanisms 260 of the vehicle to perform these tasks. As provided herein, the control mechanisms 260 can comprise a steering system, braking system, acceleration system, and/or signaling and auxiliary system of the vehicle.

In variations, the vehicle control module 250 can include an autonomous motion planning module to automatically decide a sequence of immediate motion plans for the vehicle along a travel route based on the fused environment representation and operate the control mechanisms 260 of the vehicle to autonomously drive the vehicle along the travel route in accordance with the immediate motion plans. Accordingly, the vehicle control module 250 can perform scene understanding tasks, such as determining occupancy in the grid-based representation of the surrounding environment (e.g., predicting whether each grid or three-dimensional voxel in the fused, grid-based representation is free or occupied by an object), performing object detection and classification tasks, determining right-of-way rules in any given situation, and/or generally determining various aspects of the road infrastructure, such as detecting lane markings, road signage, traffic signals, etc., determining lane and road topology, identifying crosswalks, bicycle lanes, and the like.

### Fused Sensor Environment

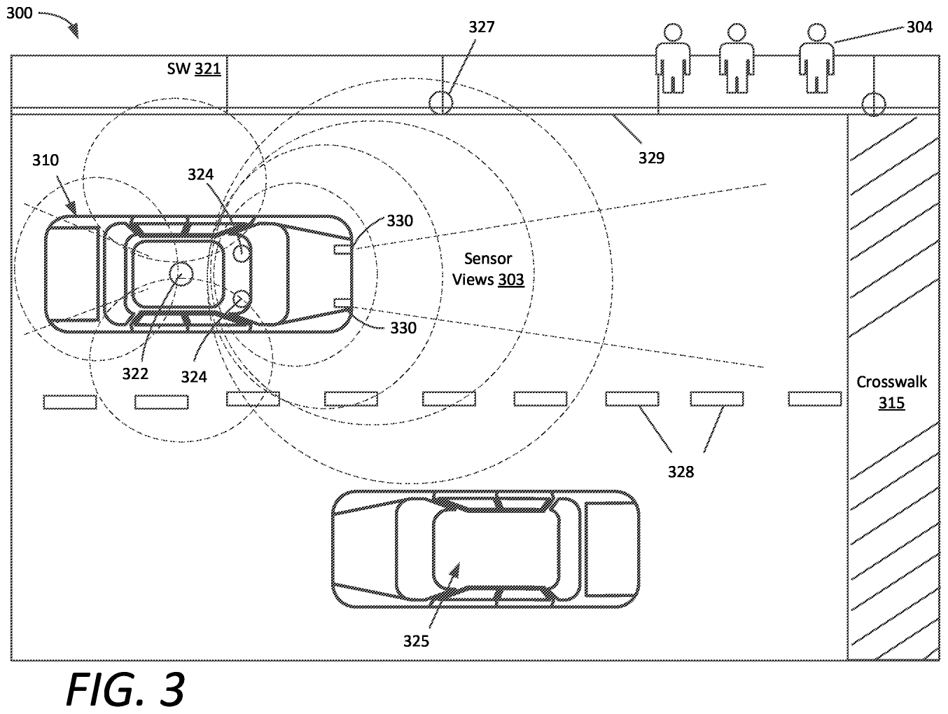

FIG. 3 depicts an example of a vehicle 310 acquiring sensor data from multiple sensor types to generate a fused representation of the surrounding environment 300 of the vehicle 310, according to examples described herein. In an example of FIG. 3, the vehicle 310 may include various sensors, such as one or more LIDAR sensors 322, cameras 324, radar sensors 330, and the like. As provided herein, the raw sensor data from these various sensors can be reprojected to BEV space and then combined or fused by a computing system 200 of the vehicle 310 to generate a traditional BEV grid map or volume. In further implementations, the computing system 200 of the vehicle 310 can further process the raw sensor data using a learned sensor data processing module 210 to reproject the raw sensor measurement into BEV space and generate a sensor-fused, learned BEV map or volume of the surrounding environment 300 of the vehicle 310.

According to an example, the computing system 200 of the vehicle 310 uses a plurality of sensor views 303 based on the various sensor type included on the vehicle 310 (e.g., a stereoscopic or three-dimensional image stream of the environment 300, one or more three-dimensional LIDAR point cloud maps, and/or radar sensor views) to perform the reprojection and/or coordinate transform to BEV space, and then perform sensor fusion and hybrid BEV techniques described herein. In various examples, the traditional BEV grid map using classical methods can capture higher-level features that may be otherwise lost in the encoding process by the learned-sensor data processing module 210. As an illustration, the machine-learning decoder 240 can generate a representation of the surrounding environment 300 using the learned BEV volume outputted by the machine-learning encoder 310, which can include objects such as pedestrians 304, parking meters 327, other vehicles 325, traffic signs and signals, etc.

Using the traditional BEV grid map or volume generated by the traditional sensor data processing module 220, the machine-learning decoder 240 can further generate the representation of the surrounding environment 300 to include more granular features, or to enable the computing system 200 of the vehicle 310 to identify and/or classify such granular features. Accordingly, the hybrid BEV grid volume outputted by the hybrid BEV module 230 of FIG. 2 can be processed by the machine-learning decoder 240 to generate the sensor-fused representation of the surrounding environment such that features such as sidewalks 321, road-side curbs 329, lane markings 328, crosswalks 315, etc. can be identified and their granular features determined. In such examples, the computing system 200 can determine the nature of the lane markings 328 (e.g., hashed versus solid lines, turning arrows, bicycle lanes, etc.), the characteristics of the curbs 329 (e.g., whether the curb 329 has a 90-degree structure or a driveway or parking lot approach structure), and the like. As such, the embodiments described herein can facilitate in capturing and classifying these more granular features that may be desired or necessary for scene understanding and feature optimization, which can further facilitate scalability of the various examples described herein to, for example, support advanced SAE levels and ODDs.

### Methodology

FIGS. 4 and 5 are flow charts describing example methods of combining a traditional BEV grid map or volume with a learned BEV volume to perform automated vehicle tasks, according to examples described herein. In the below descriptions of FIGS. 4 and 5, reference may be made to reference characters representing various features as shown and described with respect to FIGS. 1 and 2. Furthermore, the processes described in connection with FIGS. 4 and 5 may be performed by an example computing system 200 as described with respect to FIG. 2. Further still, certain steps described with respect to the flow charts of FIGS. 4 and 5 may be performed prior to, in conjunction with, or subsequent to any other step, and need not be performed in the respective sequences shown.

Referring to FIG. 4, at block 400, a vehicle computing system 200 can receive, by both a traditional sensor data processing module 220 and a learned sensor data processing module 210, raw sensor data from a sensor suite 205 of a vehicle. As described throughout the present disclosure, the sensor suite 205 can include any of one or more sensor types, such as LIDAR sensors, cameras, radar sensors, etc. In one example, the sensor suite 205 can comprise an array of a single sensor type (e.g., cameras). In variations, the sensor suite 205 comprises multiple sensor types in any combination and arrangement. At block 405, the traditional sensor data processing module 220 of the computing system 200 can generate a BEV grid map or volume using the raw sensor data and traditional reprojections models. As provided herein, the BEV grid map or volume can comprise a traditional grid map or volume using inverse sensor models. As further provided herein, the inclusion of a traditional grid map or volume can readily enable safety certification for the vehicle computing system 200 (e.g., to qualify for a particular ODD or SAE level).

At block 410, the learned sensor data processing module 210 can generate at least one learned BEV volume based on the raw sensor data from the sensor suite 205. In certain aspects, the learned sensor data processing module 210 can generate a learned BEV volume for each sensor data type, or can generate a learned, sensor-fused BEV volume comprising one sensor type, or a subset of the multiple sensor data types. In various examples, the learned BEV volume can be encoded based on a set of feature filters of a machine learning model (an encoder/decoder model for semi-autonomous or fully autonomous driving). As such, the learned sensor data processing module 210 can filter, discard, encode, and or compress various portions of the raw sensor data to generate the learned BEV volume(s).

At block 415, the vehicle computing system 200 can concatenate or otherwise combine the learn BEV volume(s) and the classical BEV grid map/volume to generate a hybrid BEV representation of the surrounding environment of the vehicle. At block 420, the vehicle computing system 200 may then process the hybrid BEV representation to derive a fused representation of the surrounding environment of the vehicle. The computing system 200 can dynamically analyze the fused representation to perform any number and combination of tasks, as described below with respect to FIG. 5.

FIG. 5 is another flow chart describing a method of combining a learned BEV volume with a classical BEV grid map to perform automated vehicle functions, in accordance with examples described herein. Referring to FIG. 5, at block 500, a vehicle computing system 200 can receive raw sensor data from the various sensors of a sensor suite 205 of a vehicle. In various examples, the sensor suite 205 can comprise different sensor types (LIDAR, camera, radar, ultrasonic, etc.) outputting LIDAR data, at block 501, radar data, at block 502, image data, at block 503, and/or ultrasonic data, at block 504.

At block 505, the computing system 200 can execute a traditional sensor data processing module 220 on the raw sensor data to generate a traditional BEV grid map or volume using inverse sensor models and/or grid sensor fusion, as described herein. As further described herein, the traditional BEV grid map or volume can comprise a two-dimensional or three-dimensional grid map. At block 510, the computing system 200 can execute a learned sensor data processing module 210 on the raw sensor data to generate a set of feature maps, which can comprise encoded sensor data based on a set of feature filters of the learned sensor data processing module 210. At block 515, the learned sensor data processing module 210 can further generate one or more learned BEV grid maps and/or volumes using the set of feature maps.

As described herein, the traditional sensor data processing module 220 can reproject a single sensor data type into BEV space to generate a single sensor data type BEV grid or volume (e.g., a LIDAR grid map or volume), or can reproject multiple sensor data types into BEV space and generate a sensor-fused BEV grid map or volume (e.g., based on LIDAR and radar data). In further implementations, the learned sensor data processing module 210 can reproject a single sensor data type into BEV space to generate a single sensor data type BEV grid or volume (e.g., an image-based BEV grid map or volume), or can reproject multiple sensor data types into BEV space and generate a sensor-fused BEV grid map or volume based on multiple sensor data types.

In various examples, at block 520, the computing system 200 can generate a hybrid BEV representation of the surrounding environment of the vehicle using the traditional BEV grid map or volume using classical methods and the learned BEV grid map or volume. As described throughout the present disclosure, the hybrid BEV representation of the surrounding environment of the vehicle can comprise a grid integration using traditional inverse sensor modeling and a learning-based approach for feature optimization that allows for certification from a functional safety perspective. At block 525, the computing system 200 can further derive various aspects of the road infrastructure in the surrounding environment of the vehicle based on the hybrid BEV representation.

The various aspects of the road infrastructure can include the road topology, lane topology, lane boundaries, road markings, crosswalks, sidewalks, parking spaces, bicycle lanes, road and traffic signage, traffic signals, right-of-way rules, and the like. In further examples, the computing system 200 can dynamically analyze the hybrid BEV representation and/or fused, grid representation of the surrounding environment to perform autonomy tasks, such as object detection, object classification, instance segmentation, motion prediction, or traffic rule determination tasks for semi-autonomous or fully autonomous driving. Accordingly, at block 530, the computing system 200 can dynamically perform advanced driver assistance functions for a driver of the vehicle, such as adaptive cruise control, emergency brake assist, lane-keeping, lane centering, highway drive assist, autonomous obstacle avoidance, and/or autonomous parking functions. Additionally or alternatively, at block 535, the computing system 200 can dynamically generate a motion plan to autonomously operate the control mechanisms 260 of the vehicle along a travel route.

It is contemplated for examples described herein to extend to individual elements and concepts described herein, independently of other concepts, ideas or systems, as well as for examples to include combinations of elements recited anywhere in this application. Although examples are described in detail herein with reference to the accompanying drawings, it is to be understood that the concepts are not limited to those precise examples. As such, many modifications and variations will be apparent to practitioners skilled in this art. Accordingly, it is intended that the scope of the concepts be defined by the following claims and their equivalents. Furthermore, it is contemplated that a particular feature described either individually or as part of an example can be combined with other individually described features, or parts of other examples, even if the other features and examples make no mention of the particular feature.

1. A computing system for automated or assisted driving, the computing system comprising:
one or more processors;
a memory storing instructions that, when executed by the one or more processors, cause the computing system to:
receive, by a traditional sensor data processing module and a learned sensor data processing module, raw sensor data from a sensor suite of a vehicle, the sensor suite comprising a plurality of sensor types;
generate, by the traditional sensor data processing module, a traditional bird's eye view (BEV) grid map or volume based on the raw sensor data;
generate, by the learned sensor data processing module, a learned BEV grid map or volume based on the raw sensor data;
combine the learned BEV grid map or volume and the traditional BEV grid map or volume to generate a hybrid BEV representation of a surrounding environment of the vehicle; and
process the hybrid BEV representation of the surrounding environment to derive a fused representation of the surrounding environment of the vehicle.

2. The computing system of claim 1, wherein the plurality of sensor types comprises any combination of a-LIDAR sensors, image sensors, radar sensors, or ultrasonic sensors.

3. The computing system of claim 1, wherein the traditional sensor data processing module performs inverse sensor modeling based on sensor measurements from the sensor suite to generate the traditional BEV grid map.

4. The computing system of claim 1, wherein the learned sensor data processing module generates a set of feature maps using the raw sensor data and generates the learned BEV grid map or volume using the set of feature maps.

5. The computing system of claim 1, wherein the executed instructions cause the computing system to process the hybrid BEV representation of the surrounding environment to derive aspects of road infrastructure of a travel route on which the vehicle operates in real-time, the aspects of the road infrastructure include one or more of road topology, lane topology, lane boundaries, road markings, crosswalks, sidewalks, parking spaces, bicycle lanes, road and traffic signage, traffic signals, or right-of-way rules.

6. The computing system of claim 1, wherein the executed instructions cause the computing system to process the hybrid BEV representation of the surrounding environment to perform scene understanding tasks.

7. The computing system of claim 6, wherein the scene understanding tasks comprise at least one of object detection, object classification, instance segmentation, motion prediction, or traffic rule determination tasks.

8. The computing system of claim 1, wherein the traditional BEV grid map or volume comprises one of a two-dimensional BEV grid map, a three-dimensional grid volume, or any n-dimensional discretized space.

9. The computing system of claim 1, wherein the learned BEV grid map or volume comprises a sensor-fused, learned BEV grid map or volume based on the raw sensor data from the plurality of sensor types.

10. The computing system of claim 1, wherein the learned BEV grid map or volume is generated using image data, and wherein the traditional BEV grid map or volume is generated using at least one of LIDAR data or radar data.

11. The computing system claim 1, wherein vehicle comprises an autonomous vehicle, and wherein the executed instructions further cause the computing system to:
dynamically analyze the fused representation of the surrounding environment to autonomously operate a set of control mechanisms of the autonomous vehicle along a travel route.

12. The computing system of claim 1, wherein the learned BEV grid map or volume is generated based on sensor data from one or more sensor types of the plurality of sensor types, and wherein the traditional BEV grid map or volume is generated based on sensor data from one or more sensor types of the plurality of sensor types.

13. The computing system of claim 1, wherein the computing system comprises an advanced driver-assistance system (ADAS), and wherein the executed instructions further cause the computing system to:
dynamically analyze the fused representation of the surrounding environment to assist a driver of the vehicle during operation of the vehicle by the driver.

14. The computing system of claim 13, wherein the executed instructions cause the ADAS to assist the driver of the vehicle by automatically performing one or more of the following: adaptive cruise control, emergency brake assist, lane-keeping, lane centering, highway assist, autonomous obstacle avoidance, or autonomous parking tasks.

15. A non-transitory computer-readable medium storing instructions that, when executed by one or more processors of a computing system, cause the computing system to:
receive, by a traditional sensor data processing module and a learned sensor data processing module, raw sensor data from a sensor suite of a vehicle, the sensor suite comprising a plurality of sensor types;
generate, by the traditional sensor data processing module, a traditional bird's eye view (BEV) grid map or volume based on the raw sensor data;
generate, by the learned sensor data processing module, a learned BEV grid map or volume based on the raw sensor data;
combine the learned BEV grid map or volume and the traditional BEV grid map or volume to generate a hybrid BEV representation of a surrounding environment of the vehicle; and
process the hybrid BEV representation of the surrounding environment to derive a fused representation of the surrounding environment of the vehicle.

16. The non-transitory computer-readable medium of claim 15, wherein the plurality of sensor types comprises any combination of LIDAR sensors, image sensors, radar sensors, or ultrasonic sensors.

17. The non-transitory computer-readable medium of claim 15, wherein the traditional sensor data processing module performs inverse sensor modeling based on sensor measurements from the sensor suite to generate the traditional BEV grid map.

18. The non-transitory computer-readable medium of claim 15, wherein the learned sensor data processing module generates a set of feature maps using the raw sensor data and generates the learned BEV grid map or volume using the set of feature maps.

19. The non-transitory computer-readable medium of claim 15, wherein the executed instructions cause the computing system to process the hybrid BEV representation of the surrounding environment to derive aspects of road infrastructure of a travel route on which the vehicle operates in real-time, the aspects of the road infrastructure include one or more of road topology, lane topology, lane boundaries, road markings, crosswalks, sidewalks, parking spaces, bicycle lanes, road and traffic signage, traffic signals, or right-of-way rules.

20. A computer-implemented method of automated or assisted driving, the method being performed by one or more processors and comprising:
receiving, by a traditional sensor data processing module and a learned sensor data processing module, raw sensor data from a sensor suite of a vehicle, the sensor suite comprising a plurality of sensor types;
generating, by the traditional sensor data processing module, a traditional bird's eye view (BEV) grid map or volume based on the raw sensor data;
generating, by the learned sensor data processing module, a learned BEV grid map or volume based on the raw sensor data;
combining the learned BEV grid map or volume and the traditional BEV grid map or volume to generate a hybrid BEV representation of a surrounding environment of the vehicle; and
processing the hybrid BEV representation of the surrounding environment to derive a fused representation of the surrounding environment of the vehicle.
